(19) United States
(12) Patent Application Publication
(10) Pub. No.: US 2003/0048919 A1
(43) Pub. Date: Mar. 13, 2003

(54) Suspension for speaker

(76) Inventor: Kuei-Feng Lin, Tatu Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/948,908

(22) Filed: Sep. 10, 2001

(51) Int. Cl. H04R 25/00; H04R 9/06

(52) U.S. Cl. 381/398; 381/171; 381/172

(57) ABSTRACT

A suspension molded from a rubber compound in a molding through a foaming process, having solid top and bottom covering layers that do not admit light, and a foamed intermediate layer integrated in between the solid covering layers.

### BACKGROUND OF THE INVENTION

The present invention relates to speakers, and more particularly, to a suspension for speaker, which achieves the advantages of a full rubber suspension as well as the advantages of a foamed suspension.

Regular suspensions for speaker include two types, namely, the full rubber suspension and the foamed suspension. FIG. 1 illustrates the fabrication of a full rubber suspension according to the prior art. As illustrated, a solid rubber plate 10 is pressed into a semi-finished product A, and then the center waste material 12 and peripheral waste material 13 are separated from the suspension body 11, and thus the desired finished product B is obtained. The finished product B has a solid structure C that does not admit air. This design of full rubber suspension is durable in use and capable of producing a thick sound quality. However, it has numerous drawbacks as follows:

1. It is less sensitive has a high distortion rate due to high specific gravity (about 1.2˜1.4).

2. It limits the performance of the output power of the cone due to high drag force of rubber material.

3. It must be used with a relatively heavy magnetic core to achieve the desired power output due to high drag force of rubber material.

4. Much center waste material 12 is produced during its fabrication.

5. It fits the requirement for thick sound quality but not suitable for the requirement for tender sound quality.

FIG. 2 illustrates the fabrication of a foamed suspension according to the prior art. As illustrated, a foamed plate 20 is prepared and pressed into a semi-finished product A, and then the center waste material 22 and peripheral waste material 23 are separated from the suspension body 21, and thus the desired finished product B is obtained. The finished product B has air holes D in it. This design of foamed suspension achieves high power output and produces tender sound quality. However, it has numerous drawbacks as follows:

1. It cannot produce a thick sound effect because of low specific gravity of foamed material.

2. It achieves high power output, however tends to cause a distortion due to low specific gravity and low drag force.

3. It cannot eliminate an air leakage during vibration of the cone because it has air holes in its suspension body.

4. It is not durable in use because foamed material deteriorates quickly under the action of the weather.

5. Much center waste material 22 is produced during its fabrication.

6. It is not suitable for use in a speaker that requires a thick sound quality.

### SUMMARY OF THE INVENTION

The present invention has been accomplished to provide a suspension for speaker, which eliminates the aforesaid drawbacks. It is the main object of the present invention to provide a suspension for speaker, which achieves the advantages of a full rubber suspension as well as the advantages of a foamed suspension. According to the present invention, the suspension is molded from a rubber compound in a molding through a foaming process, having solid top and bottom covering layers that do not admit light, and a foamed intermediate layer integrated in between the solid covering layers.

### BRIEF DESCRIPTION OF THE DRAWINGS

FIG. 1 illustrates the fabrication of a full rubber suspension according to the prior art.

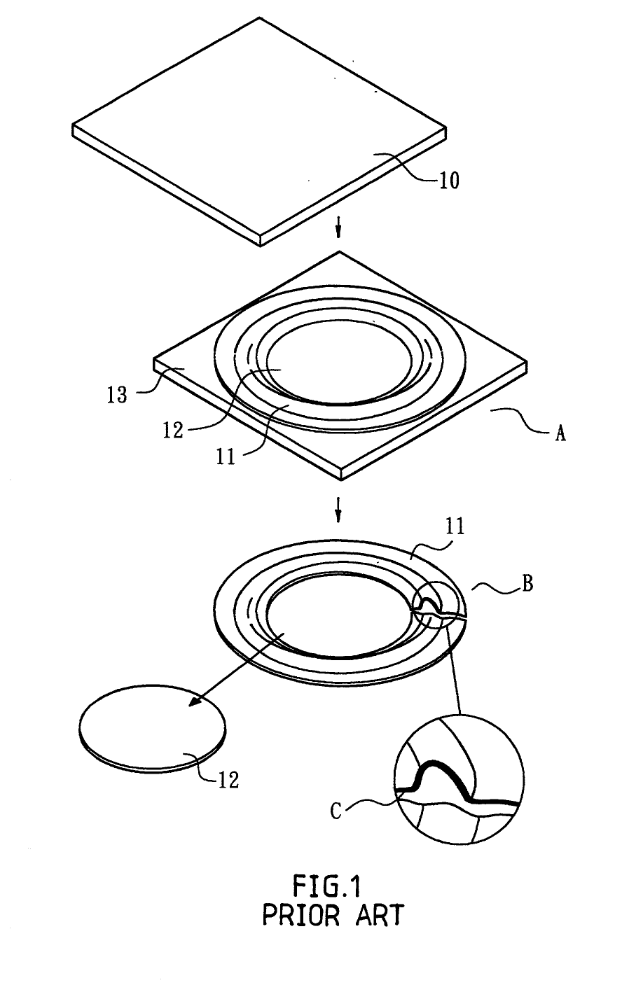

FIG. 2 illustrates the fabrication of a foamed suspension according to the prior art.

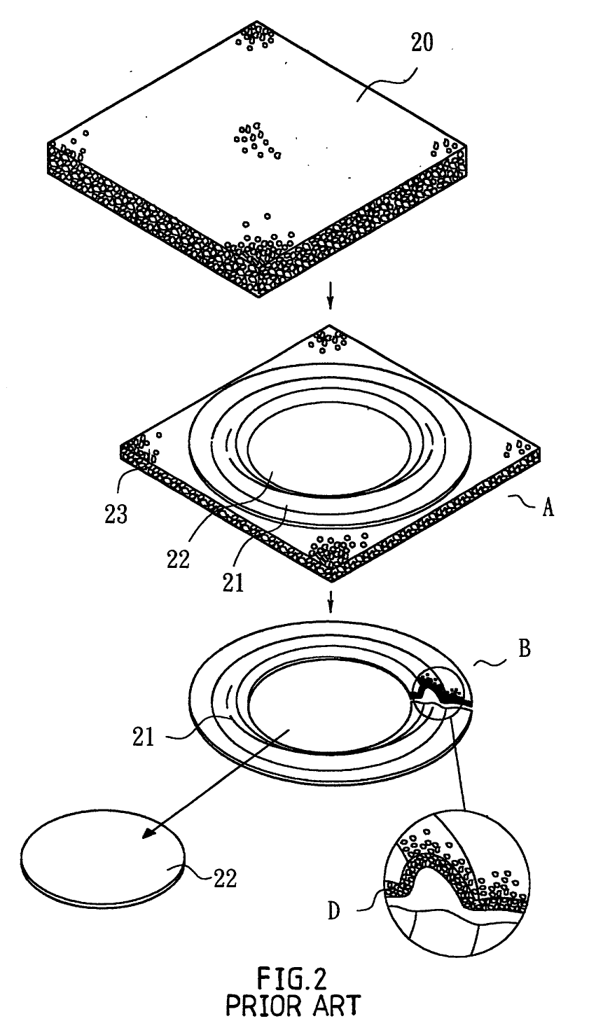

FIG. 3 illustrates a raw suspension cut into a finished suspension according to the present invention.

FIG. 4 illustrates the molding of a raw suspension according to the present invention.

### DETAILED DESCRIPTION OF THE PREFERRED EMBODIMENT

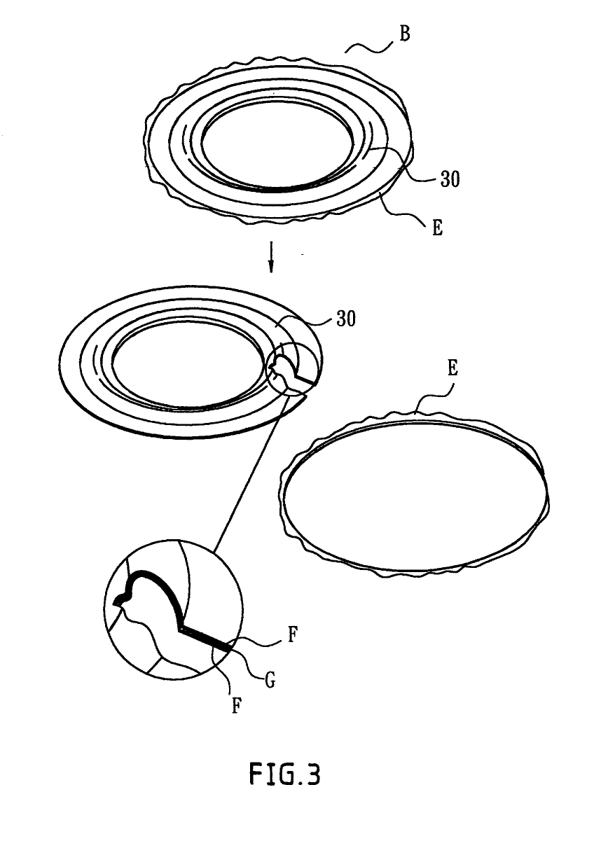

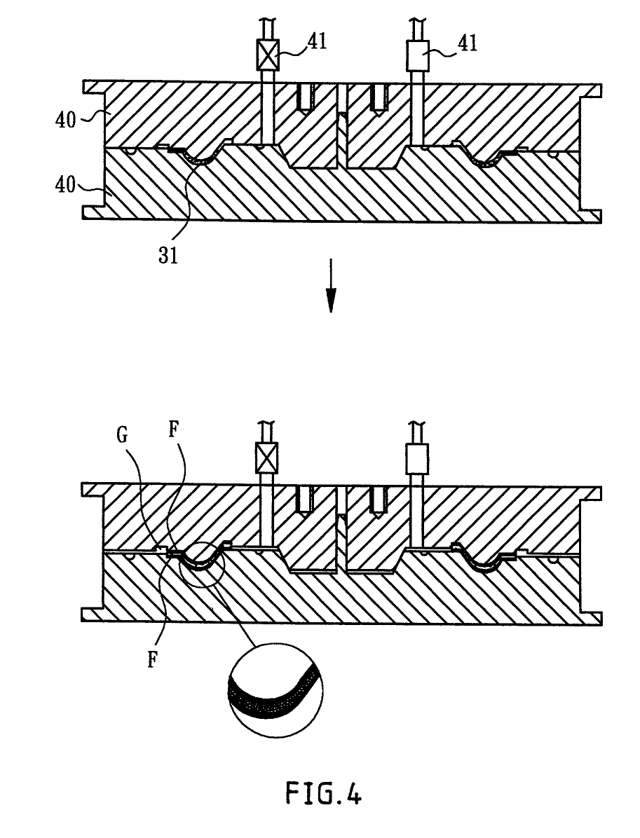

Referring to FIGS. 3 and 4, a proper amount of rubber compound 31 (containing sulfur bridging agent) is filled in a mold 40 and then molded into the desired suspension 30. The suspension 30 has solid top and bottom covering layers F that do not admit light, and a foamed intermediate layer G integrated in between the solid covering layers F.

Referring to FIG. 4 again, the mold 40 has two air inlets connected to a vacuum generation controller 41. Prepared rubber compound 31 (which contains sulfur bridging agent) is filled into the mold 40, and then the vacuum generation controller 41 is operated to draw the cavity of the mold 40 into a vacuum status when heating the mold 40 to cause rubber compound 31 to produce a catalytic action when heating the mold 40. A certain length of time after the catalytic action, the mold 40 is slightly opened to let outside air pass to the inside of the mold 40, causing catalyzed rubber compound 31 to produce a foaming action. After foaming, a raw suspension is obtained. After cut off the rough peripheral edge E, the desired finished produce is obtained.

As indicated, the suspension of the present invention achieves the following advantages:

1. It has the solid covering layers F and the foamed layer G and a proper specific gravity about 0.4˜0.6.

2. It achieves high sensitivity and low distortion.

3. It is highly flexible to enhance output power and to reduce distortion due to the effect of the solid covering layers and the foamed intermediate layer.

4. It does not admit light, and eliminates the problem of distortion due to air penetration.

5. It has the characteristics of full rubber material to provide satisfactory sound quality.

6. It has the characteristics of foamed material to provide tender sound quality.

7. It is durable in use because of the quality of full rubber material.

8. It minimizes the dimension requirement of the magnetic core.

9. It minimizes the production of waste material during its fabrication.

What the invention claimed is:

1. A suspension molded from a rubber compound in a molding through a foaming process, having solid top and bottom covering layers that do not admit light, and a foamed intermediate layer integrated in between said solid covering layers.
